(19) United States
(12) Patent Application Publication
(10) Pub. No.: US 2011/0080425 A1
(43) Pub. Date: Apr. 7, 2011

(54) SYSTEM FOR PROVIDING MULTI-ANGLE BROADCASTING SERVICE

(75) Inventors: Nac Woo KIM, Gwangju (KR); Ilkyun PARK, Seoul (KR); Sim-Kwon YOON, Gwangju (KR); Kyunghun KIM, Gwangju (KR); Byung-Tak LEE, Gyeonggi-do (KR); Jai Sang KOH, Gwangju (KR)

(73) Assignee: Electronics and Telecommunications Research Institute, Daejeon (KR)

(21) Appl. No.: 12/898,438

(22) Filed: Oct. 5, 2010

(30) Foreign Application Priority Data
Oct. 5, 2009 (KR) 10-2009-0094289
Jun. 25, 2010 (KR) 10-2010-0060555

(51) Int. Cl. G09G 5/00

(52) U.S. Cl. 345/629

(57) ABSTRACT

Provided is a system for providing a multi-angle broadcasting service. A transmission apparatus may transmit, to a reception apparatus, a plurality of source images photographed at a plurality of angles and a multi-screen image including the plurality of source images. The reception apparatus may receive the multi-screen image and decode a source image based on a user selection.

### CROSS-REFERENCE TO RELATED APPLICATIONS

This application claims the benefit of Korean Patent Application No. 10-2009-0094289, filed on Oct. 5, 2009, and Korean Patent Application No. 10-2010-0060555, filed on Jun. 25, 2010, in the Korean Intellectual Property Office, the disclosures of which are incorporated herein by reference.

### BACKGROUND

1. Field of the Invention

The present invention relates to a system for providing a broadcasting service, and more particularly, to a system for providing a multi-angle broadcasting service that may transmit an image acquired by photographing a single event at various angles.

2. Description of the Related Art

A multi-angle broadcasting service may acquire an image by photographing a single event at various angles and service the image to a user.

FIG. 1 is a diagram illustrating a concept of a multi-angle broadcasting service according to a related art.

Referring to FIG. 1, a baseball game played in a baseball stadium 110 may be a single event. To broadcast the baseball game, the baseball game may need to be photographed from various directions such as outfield directions 121, 122, and 123, infield directions 124, 125, and 126, and the like. Generally, a broadcasting station may select an image acquired by photographing a most important scene while the baseball game is in progress, and may transmit the selected image to a user.

The multi-angle broadcasting service corresponds to a broadcasting service of providing the user with a single source image selected by the user from a plurality of source images of the baseball game photographed at different locations. The user may view the source image directly selected by the user, instead of viewing a source image selected by the broadcasting station. Since the user can view a source image photographed at the user's desired angle, a user satisfaction may increase.

The user may simultaneously view a plurality of source images 131, 132, 133, 134, 135, and 136 using a display device 130. The user may select a single source image photographed from the user's desired viewpoint. The user may view the selected source image.

### SUMMARY

An aspect of the present invention provides a multi-angle broadcasting service by minimizing a change of a receiver.

Another aspect of the present invention also provides an inexpensive receiver that may receive a multi-angle broadcasting service.

According to an aspect of the present invention, there is provided a transmission apparatus, including: a receiver to receive a plurality of source images photographed from a plurality of viewpoints; a multi-screen image generator to generate a multi-screen image including the plurality of source images; and a transmitter to transmit the multi-screen image to a reception apparatus.

According to another aspect of the present invention, there is provided a reception apparatus, including: an image receiver to receive a plurality of source images photographed from a plurality of viewpoints and a multi-screen image including the plurality of source images; a user selection receiver to receive a user's selection on one source image among the plurality of source images included in the multi-screen image; and an image decoder to decode the selected source image according to the user's selection.

According to still another aspect of the present invention, there is provided reception apparatus, including: an image receiver to receive a plurality of source images photographed from a plurality of viewpoints and a multi-screen image including the plurality of source images; a metadata receiver to receive metadata about the multi-screen image; and an image decoder to decode, based on the metadata, a source image selected based on the multi-screen image.

According to embodiments of the present invention, it is possible to provide a multi-angle broadcasting service by minimizing a change of a receiver.

Also, according to embodiments of the present invention, it is possible to provide an inexpensive receiver that may receive a multi-angle broadcasting service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a concept of a multi-angle broadcasting service according to a related art;

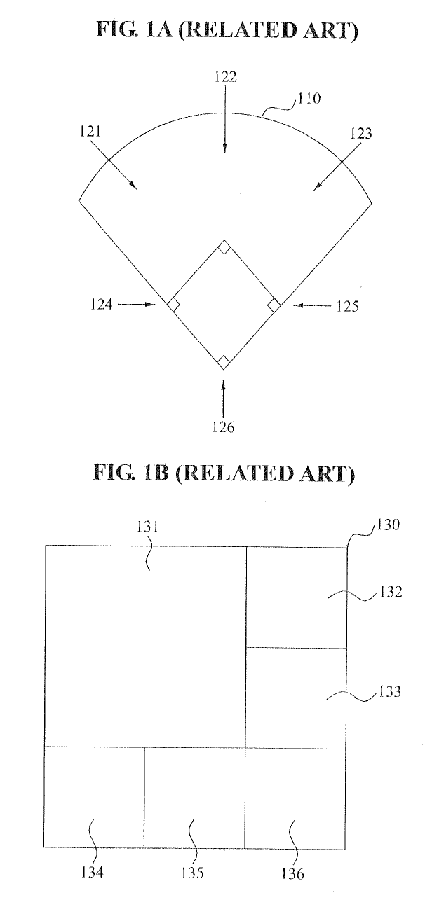

FIG. 2 is a diagram illustrating a concept of converting a multi-screen image and a source image based on a user's selection to thereby perform decoding according to an embodiment of the present invention;

FIG. 3 is a block diagram illustrating a structure of a transmission apparatus according to an embodiment of the present invention;

FIG. 4 is a block diagram illustrating a structure of a reception apparatus according to an embodiment of the present invention; and

FIG. 5 is a block diagram illustrating a structure of a reception apparatus according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

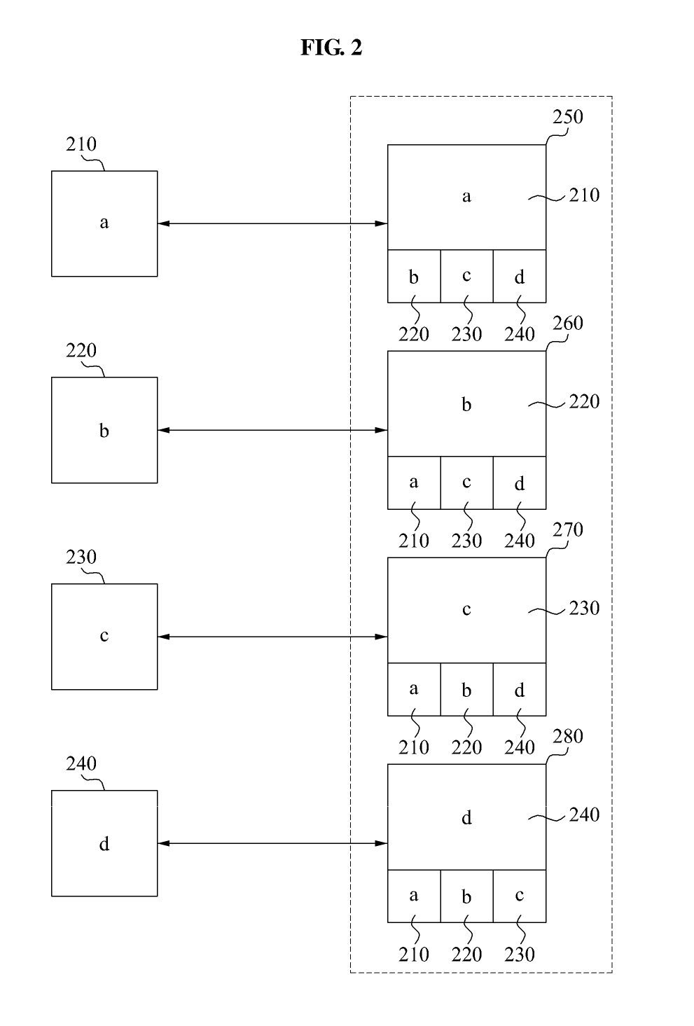

FIG. 2 is a diagram illustrating a concept of converting a multi-screen image and a source image based on a user's selection to thereby perform decoding according to an embodiment of the present invention.

According to an embodiment of the present invention, a transmission apparatus may transmit, to a reception apparatus, a plurality of source images and a multi-screen image including the plurality of source images.

Referring to FIG. 2, a user may view a first multi-screen image 250 including a first source 210, a second source image 220, a third source image 230, and a fourth source image 240. In the first multi-screen image 250, a size of the first source image 210 is larger than sizes of remaining source images, that is, the second source image 220, the third source image 230, and the fourth source image 240.

When the user selects the first source image 210 include in the first multi-screen image 250, the reception apparatus may select and decode the first source image 210.

When the user selects another source image in the first multi-screen image 250, the reception apparatus may decode a multi-screen image where a size of the source image selected by the user is largest, among a second multi-screen image 260, a third multi-screen image 270, and a fourth multi-screen image 280. For example, when the user selects the second source image 220 included in the first multi-screen image 250, the reception apparatus may select the second multi-screen image 260 where the size of the second source image 220 is largest, and may decode the selected second multi-screen image 260.

When the user selects the second source image 220 included in the second multi-screen image 260, the reception apparatus may select and decode the second source image 220. However, when the user selects the third source image 230 or the fourth source image 240 included in the second multi-screen image 260, the reception apparatus may decode the third multi-screen image 270 or the fourth multi-screen image 280. In the third multi-screen image 270, the third source image 230 may have a largest size among the first source image 210, the second source image 220, the third source image 230, and the fourth source image 240. In the fourth multi-screen image 280, the fourth source image may have a largest size among the first source image 210, the second source image 220, the third source image 230, and the fourth source image 240.

Specifically, the user may select a single source image based on a multi-screen image where a plurality of source images is simultaneously reproduced. The reception apparatus may decode another multi-screen image where a size of the source image selected by the user is reproduced to be relatively large, or may decode the source image selected by the user.

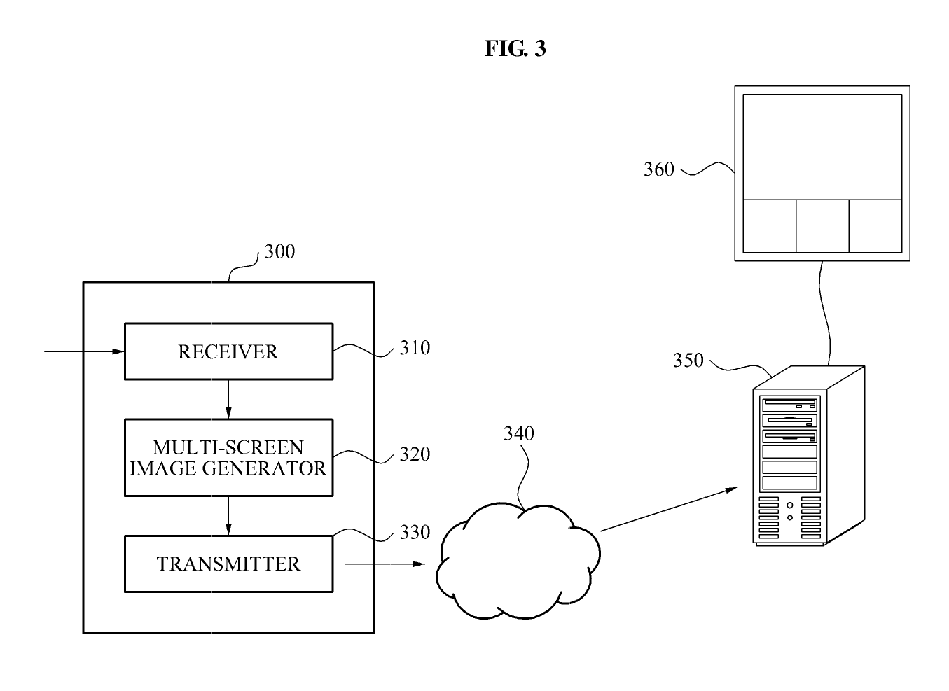

FIG. 3 is a block diagram illustrating a structure of a transmission apparatus 300 according to an embodiment of the present invention.

Referring to FIG. 3, the transmission apparatus 300 may include a receiver 310, a multi-screen image generator 320, and a transmitter 330.

The receiver 310 may receive a plurality of source images. The plurality of source images may be generated by photographing the same event from a plurality of viewpoints. For example, a first source image may be generated by photographing a baseball game from a first-base direction, and a second source image may be generated by photographing the baseball game from a third-base direction.

The multi-screen image generator 320 may generate a multi-screen image including the plurality of source images. The multi-screen image may include the plurality of source images in a single screen. For example, the multi-screen image may include a first source image in a left side of the screen and a second source image in a right side of the screen. For example, the user may simultaneously view a scene of the baseball game photographed from the first-base direction and a scene of the baseball game photographed from the third-base direction, by referring to the first source image and the second source image in the multi-screen image.

The multi-screen image generator 320 may generate the multi-screen image so that a size of a particular source image among the plurality of source images included in the multi-screen image may be larger than a size of at least one remaining source image.

The multi-screen image generator 320 may generate a plurality of multi-screen images. In this case, the multi-screen image generator 320 may generate a first multi-screen image where a size of the first source image is larger than a size of the second source image, and may generate a second multi-screen image where the size of the second source image is larger than the size of the first source image. The first multi-screen image and the second multi-screen image may include the first source image and the second source image. Here, each source image included in each multi-screen image may have a different size.

Also, each source image included in each multi-screen image may be positioned in a different location. For example, in the first multi-screen image, the first source image may be positioned in an upper portion of a corresponding screen. In the second multi-screen image, the second source image may be positioned in an upper portion of a corresponding screen.

The transmitter 330 may transmit a multi-screen image to a reception apparatus 350 over a network 340. In addition to the multi-screen image, the transmitter 330 may additionally transmit source images to the reception apparatus 350.

The transmitter 330 may transmit the multi-screen image and the source images to the reception apparatus 350 using the same channel. Also, the transmitter 330 may transmit the multi-screen image and the source images to the reception apparatus 350 using different channels.

The reception apparatus 350 may decode the multi-screen image. The decoded multi-screen image may be provided to a user using the display device 360. The user may select a particular source image based on the decoded multi-screen image. In this case, the reception apparatus 350 may decode the particular source image selected by the user from the source images received from the transmission apparatus 300.

The reception apparatus 350 may also decode another multi-screen image based on the decoded multi-screen image.

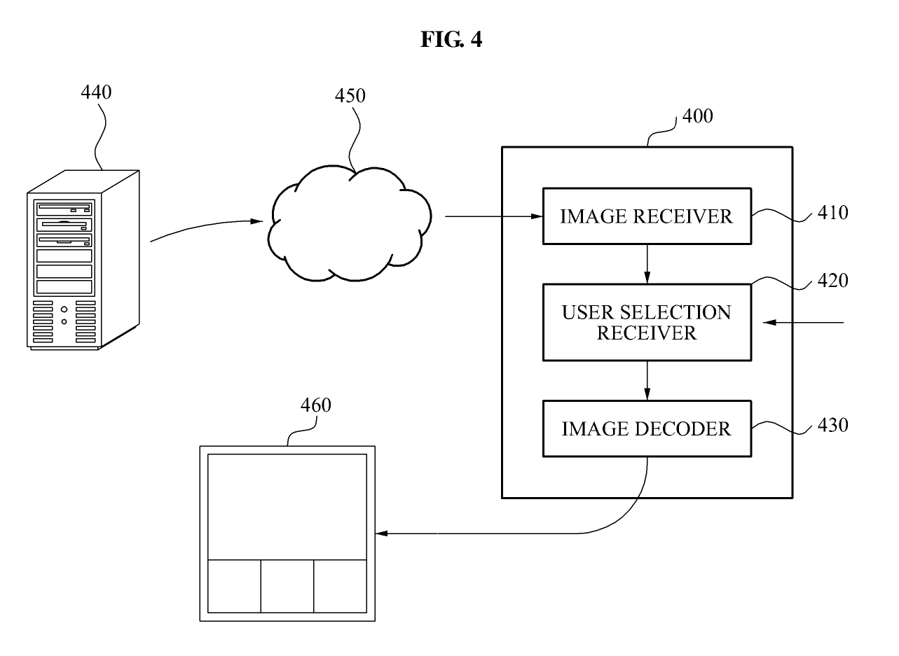

FIG. 4 is a block diagram illustrating a structure of a reception apparatus 400 according to an embodiment of the present invention.

Referring to FIG. 4, the reception apparatus 400 may include an image receiver 410, a user selection receiver 420, and an image decoder 430.

The image receiver 410 may receive, from a transmission apparatus 440 over a network 450, a plurality of source images photographed from a plurality of viewpoints and a multi-screen image including the plurality of source images.

The multi-screen image may include the plurality of source images. Among the plurality of source images, a size of a particular source image may be larger than a size of at least one remaining source image.

The image receiver 410 may receive a plurality of multi-screen images. When the image receiver 410 receives a first multi-screen image and a second multi-screen image including a first source image and a second source image, a size of the first source image may be larger than a size of the second source image in the first multi-screen image. In the second multi-screen image, the size of the second source image may be larger than the size of the first source image.

Also, in the first multi-screen image, the first source image may be positioned in an upper portion of a screen. In the second multi-screen image, the second source image may be positioned in an upper portion of a screen.

The image receiver 410 may receive, from the transmission apparatus 440, the multi-screen image and the source images using the same channel. Also, the image receiver 410 may receive, from the transmission apparatus 440, the multi-screen image and the source images using different channels.

A user may view a multi-screen image displayed on a display device 460, and may select a single source image from the source images. The user selection receiver 420 may receive the user's selection on the single source image among the source images included in the multi-screen image.

The image decoder 430 may decode the source image selected by the user, or may decode another multi-screen image where a size of the selected source image is reproduced to be relatively large.

As one example, when the display device 460 displays the first multi-screen image where the size of the first source image is larger than the size of the second source image, the user may select the first source image. The user selection receiver 420 may receive the user's selection on the first source image from the user. The image decoder 430 may decode the first source image.

As another example, when the display device 460 displays the first multi-screen image where the size of the first source image is larger than the size of the second source image, the user may select the second source image. The user selection receiver 420 may receive the user's selection on the second source image from the user. The image decoder 430 may decode the second multi-screen image where the size of the second source image is reproduced to be larger than the size of the first source image. When the user selects the second source image based on the second multi-screen image, the user selection receiver 420 may receive the user's section on the second source image from the user. The image decoder 430 may decode the second source image.

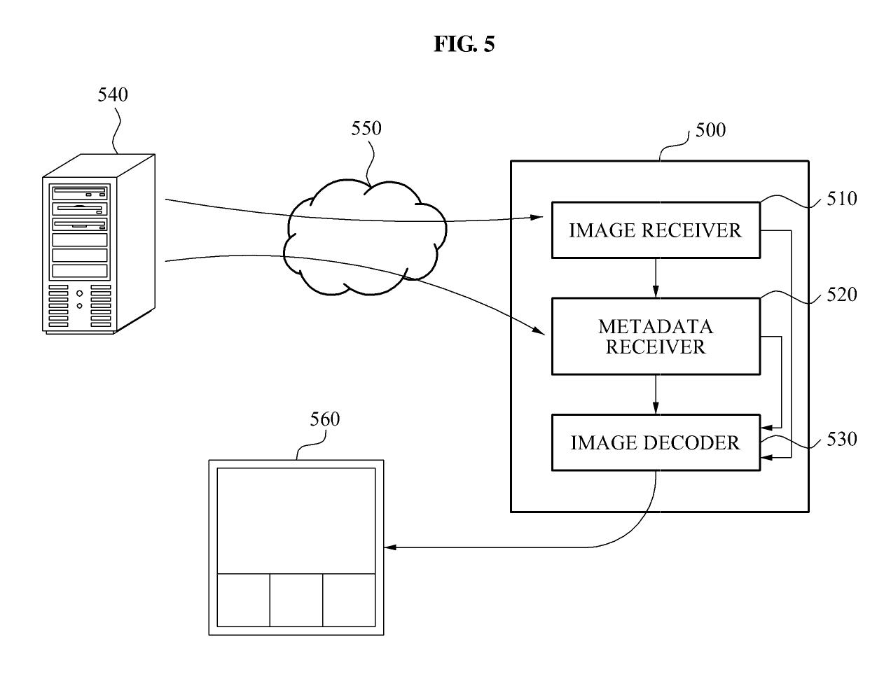

FIG. 5 is a block diagram illustrating a structure of a reception apparatus 500 according to another embodiment of the present invention.

Referring to FIG. 5, the reception apparatus 500 may include an image receiver 510, a metadata receiver 520, and an image decoder 530.

The image receiver 510 may receive, from a transmission apparatus 540 over a network 550, a plurality of source images photographed from a plurality of viewpoints and a multi-screen image including the plurality of source images.

The image receiver 510 may receive a plurality of multi-screen images. When the image receiver 510 receives a first multi-screen image and a second multi-screen image including a first source image and a second source image, a size of the first source image may be larger than a size of the second source image in the first multi-screen image. In the second multi-screen image, the size of the second source image may be larger than the size of the first source image.

Also, in the first multi-screen image, the first source image may be positioned in an upper portion of a screen. In the second multi-screen image, the second source image may be positioned in an upper portion of a screen.

The metadata receiver 520 may receive metadata with respect to a multi-screen image. The metadata corresponds to data including information associated with a characteristic of the multi-screen image. For example, the metadata may include information regarding a number of source images received from the transmission apparatus 540, a number of source images included in each multi-screen image, an identifier of each of the source images included in each multi-screen image, a largest source image among the source images included in each multi-screen image, and the like.

A user may view a multi-screen image displayed on a display device 560, and select a single source image from the source images included in the multi-screen image.

The image decoder 530 may decode, based on the metadata, the source image selected based on the multi-screen image.

As one example, when the display device 560 displays the first multi-screen image where the size of the first source image is larger than the size of the second source image, the user may select the first source image. The metadata receiver 520 may recognize that the first source image and the second source image are included in the first multi-screen image by referring to metadata with respect to the first multi-screen image. Also, the metadata receiver 520 may determine the size of the first source image and the size of the second source image included in the first multi-screen image, by referring to the metadata with respect to the first multi-screen image. The metadata receiver 520 may determine whether a source image having a largest size in the first multi-screen image is selected. When the first source image having the largest size in the first multi-screen image is determined to be selected, the image decoder 530 may decode the first source image based on the decision result of the metadata receiver 520.

As another example, when the display device 560 displays the first multi-screen image where the size of the first source image is larger than the size of the second source image, the user may select the second source image. When the size of the second source image selected by the user is determined to be smaller than the size of the first source image, the metadata receiver 520 may determine a multi-screen image where the size of the second source image is largest by referring to metadata with respect to multi-screen image. The image decoder 530 may decode a second multi-screen image where the size of the second source image is largest.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A transmission apparatus, comprising:
a receiver to receive a plurality of source images photographed from a plurality of viewpoints;
a multi-screen image generator to generate a multi-screen image comprising the plurality of source images; and
a transmitter to transmit the multi-screen image to a reception apparatus.

2. The transmission apparatus of claim 1, wherein the multi-screen image generator generates the multi-screen image so that a size of a particular source image among the plurality of source images is larger than a size of at least one remaining source image.

3. The transmission apparatus of claim 2, wherein:
the plurality of source images comprises a first source image and a second source image, and
the multi-screen image generator generates a first multi-screen image where a size of the first source image is larger than a size of the second source image, and generates a second multi-screen image where the size of the second source image is larger than the size of the first source image.

4. The transmission apparatus of claim 1, wherein the transmitter additionally transmits the plurality of source images to the reception apparatus.

5. The transmission apparatus of claim 4, wherein the transmitter transmits the plurality of source images and the multi-screen image using the same channel.

6. The transmission apparatus of claim 4, wherein the transmitter transmits the plurality of source images and the multi-screen image using different channels.

7. A reception apparatus, comprising:
an image receiver to receive a plurality of source images photographed from a plurality of viewpoints and a multi-screen image comprising the plurality of source images;
a user selection receiver to receive a user's selection on one source image among the plurality of source images included in the multi-screen image; and
an image decoder to decode the selected source image according to the user's selection.

8. The reception apparatus of claim 7, wherein, in the multi-screen image, a size of a particular source image among the plurality of source images is larger than a size of at least one remaining source image.

9. The reception apparatus of claim 8, wherein:
the plurality of source images comprises a first source image and a second source image, and
the image receiver receives a first multi-screen image where a size of the first source image is larger than a size of the second source image, and receives a second multi-screen image where the size of the second source image is larger than the size of the first source image.

10. The reception apparatus of claim 9, wherein when the user selection receiver receives the user's selection on the first source image included in the first multi-screen image, the image decoder decodes the first source image.

11. The reception apparatus of claim 9, wherein when the user selection receiver receives the user's selection on the second source image included in the first multi-screen image, the image decoder decodes the second multi-screen image.

12. The reception apparatus of claim 7, wherein the image receiver receives the plurality of source images and the multi-screen image using the same channel.

13. The reception apparatus of claim 7, wherein the image receiver receives the plurality of source images and the multi-screen image using different channels.

14. A reception apparatus, comprising:
an image receiver to receive a plurality of source images photographed from a plurality of viewpoints and a multi-screen image comprising the plurality of source images;
a metadata receiver to receive metadata about the multi-screen image; and
an image decoder to decode, based on the metadata, a source image selected based on the multi-screen image.

15. The reception apparatus of claim 14, wherein:
the plurality of source images comprises a first source image and a second source image, and
the image receiver receives a first multi-screen image where a size of the first source image is larger than a size of the second source image, and receives a second multi-screen image where the size of the second source image is larger than the size of the first source image.

16. The reception apparatus of claim 15, wherein the metadata comprises at least one of information associated with a number of source images and information associated with a largest source image among the plurality of source images included in the multi-screen image.

17. The reception apparatus of claim 15, wherein:
when the first source image is selected based on the first multi-screen image, the metadata receiver determines a size of the first source image and a size of the second source image in the multi-screen image by referring to the metadata, and
the decoder decodes the first source image depending on the decision result.

18. The reception apparatus of claim 15, wherein:
when the first source image is selected based on the first multi-screen image, the metadata receiver determines a size of the first source image and a size of the second source image in the multi-screen image by referring to the metadata, and
the decoder decodes the second multi-screen image depending on the decision result.
